(19) United States
(12) Patent Application Publication
(10) Pub. No.: US 2007/0231627 A1
(43) Pub. Date: Oct. 4, 2007

(54) CONCENTRATION DETECTION DEVICE AND THE DETECTION METHOD

(76) Inventors: Yachien Chung, Taipei (TW); Yi-Hsien Chen, Taipei (TW); Feng-Yi Deng, Taipei (TW); Yu Lin Tang, Taipei (TW)

Correspondence Address: G. LINK CO ., LTD, 3550 BELL ROAD, MINOOKA, IL, 60447, US

(21) Appl. No.: 11/692,191

(22) Filed: Mar. 28, 2007

(30) Foreign Application Priority Data
Mar. 30, 2006 (TW) 095111087

(51) Int. Cl. H01M 8/00

(52) U.S. Cl. 429/13

(57) ABSTRACT

The present invention provides a concentration detection device, which is used to detect the concentration of liquid fuel within a container. The device comprises: a float, which is floating on the surface of liquid fuel, wherein the upper portion of the float has a figure of a first reference circle, and the float is just formed as a figure of a first intersection circle on the surface of liquid fuel; an image capture device with an imaging plane, wherein the imaging plane is configured upon the float; a sunshade, wherein the sunshade is configured between the imaging plane and the float, and the sunshade is configured with a hole, so the figures of the first reference circle and the first intersection circle could be respectively projected onto the imaging plane through the hole to form a second reference circle and a second intersection circle; a calculation device, which could calculate the concentration of the liquid fuel according to the first and second reference circles and the first and second intersection circles.

### FIELD OF THE INVENTION

The present invention relates to a concentration detection device and the detection method, and particularly a liquid fuel concentration detection method for liquid fuel cell and the detection device.

### BACKGROUND OF THE INVENTION

The fuel cell is a generation device for directly transforming the chemical energy stored in fuel and oxidant into electrical energy through the electrode reaction. There are numerous types of fuel cell, and with different categorization methods. If the fuel cells are categorized by the difference of electrolyte characteristics, there are five types of fuel cells with different electrolytes, such as alkaline fuel cell, phosphorous acid fuel cell, proton exchange membrane fuel cell, molten carbonate fuel cell, solid oxide fuel cell; wherein, the proton exchange membrane fuel cell contains the so-called direct methanol fuel cell, which directly uses the methanol as the fuel without transforming into hydrogen first, and becomes one of the technologies with higher research and development capacity. The application targets include the large-scale power generation plant, generator for mobile and portable power unit, etc.

However, the liquid fuel cell, such as direct methanol fuel cell, must overcome a problem in the commercialization process, that is, the control of fuel cell concentration. Theoretically speaking, the lower the fuel concentration is, the less the power generated; the higher the fuel concentration is, the more the power generated. Thus, it is required a concentration detection device to monitor the concentration of fuel cell anytime, so as to ensure the concentration to be maintained at a default standard, and sustain the power supply quality for the fuel cell, and the electronic product would not be damaged due to instability of power supply from fuel cell.

### SUMMARY OF INVENTION

The object of the present invention is to provide a concentration detection device for fuel cell and the detection method, which is used to monitor the required liquid fuel concentration of fuel cell anytime, so whenever the concentration is changed, it could be reacted in real-time.

To this end, the present invention provides a concentration detection device, which is used to detect the concentration of liquid fuel within a container. The concentration detection device comprises: a float, which is floating on the surface of liquid fuel, wherein the upper portion of the float has a figure of a first reference circle, and the float is just formed as a figure of a first intersection circle on the surface of liquid fuel; an image capture device with an imaging plane, wherein the imaging plane is configured upon the float; a sunshade, wherein the sunshade is configured between the imaging plane and the float, and the sunshade is configured with a hole, so the figures of the first reference circle and the first intersection circle are projected onto the imaging plane through the hole to form a second reference circle and a second intersection circle; a calculation device, which could calculate the concentration of the liquid fuel according to the first and second reference circles and the first and second intersection circles. Moreover, the present invention further provides a detection method for liquid fuel concentration of liquid fuel cell.

### BRIEF DESCRIPTION OF DRAWINGS

The foregoing aspects, as well as many of the attendant advantages and features of this invention will become more apparent by reference to the following detailed description, when taken in conjunction with the accompanying drawings, wherein:

FIG. 1A is a side view of a preferred embodiment for a concentration detection device according to the present invention;

FIG. 1B is a perspective view of the concentration detection device in FIG. 1A;

FIGS. 2A and 2B are the concentration detection method of liquid fuel for liquid fuel cell according to the present invention, and

FIG. 3 is an image captured on the imaging plane (140) in FIG. 1B.

### DETAILED DESCRIPTION OF THE INVENTION

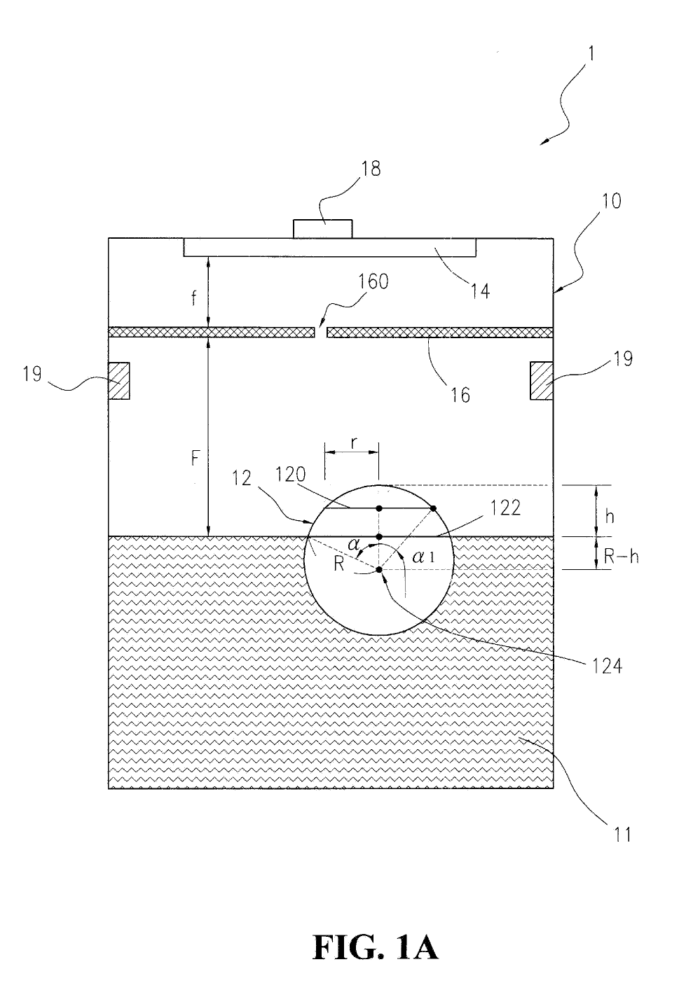

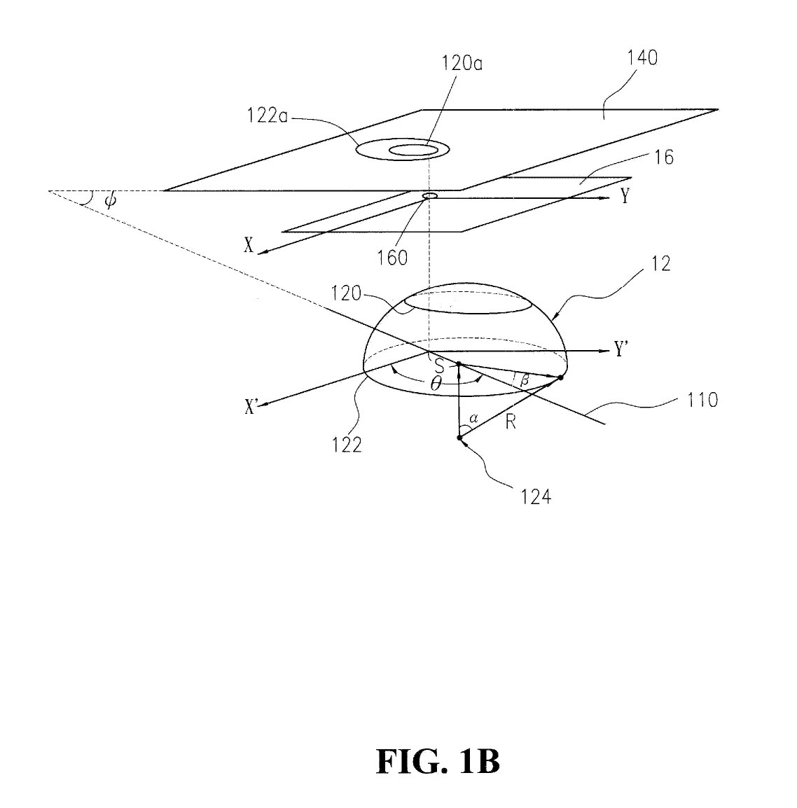

FIG. 1A is a side view of a preferred embodiment for a concentration detection device according to the present invention. FIG. 1B is a perspective view for the concentration detection device in FIG. 1A. The concentration detection device 1 according to the present invention is used to detect the concentration of liquid fuel 11 within a container 10, and particularly for the fuel concentration detection operation of liquid fuel cell. Thus, the container 10 is a fuel supply tank for supplying the fuel required by the liquid fuel cell, such as direct methanol fuel cell, and the liquid fuel 11 within the container 10 is usually the methanol aqueous solution.

As shown in FIG. 1A, the concentration detection device 1 comprises: a float 12, which is floating on the surface of liquid fuel 11. As shown in FIGS. 1A and 1B, the float 12 is a ball, and the upper portion of the float 12 has a figure of a first reference circle 120, and the float 12 is just formed as a figure of a first intersection circle 122 on the surface of liquid fuel 11.

A image capture device 14 is provided with an imaging plane 140, in which the imaging plane 140 is configured upon the float 12; and, the image capture device 14 usually employs a CCD or CMOS sensing devices as the embodied element.

A sunshade 16 is configured between the imaging plane 140 and the float 12, wherein the sunshade 16 is configured with a hole 160, so the figures of the first reference circle 120 and the first intersection circle 122 are projected onto the imaging plane 140 through the hole 160 to form a second reference circle 120a and a second intersection circle 122a.

A calculation device 18 could calculate the concentration of liquid fuel 11 based on the data of the first and second reference circles 120, 120a and the first and second intersection circles 122, 122a; wherein, the calculation device 18 is a microprocessor, and electrically connected to an image capture device 14, to obtain the image data of the second reference circle 120a and the second intersection circle 122a on the imaging plane 140 as the concentration calculation step in the concentration detection operation according to the present invention. Furthermore, as shown in FIG. 1A, in order to provide the light source compensation required for image capture by the image capture device 14, the present invention further comprises at least one light emitting device 19, in which the light emitting device 19 could be embodied with the light emitting diode. And, the light emitting devices 19 are configured on the inner wall of the container 10, below the sunshade 16, and above the surface of liquid fuel 11.

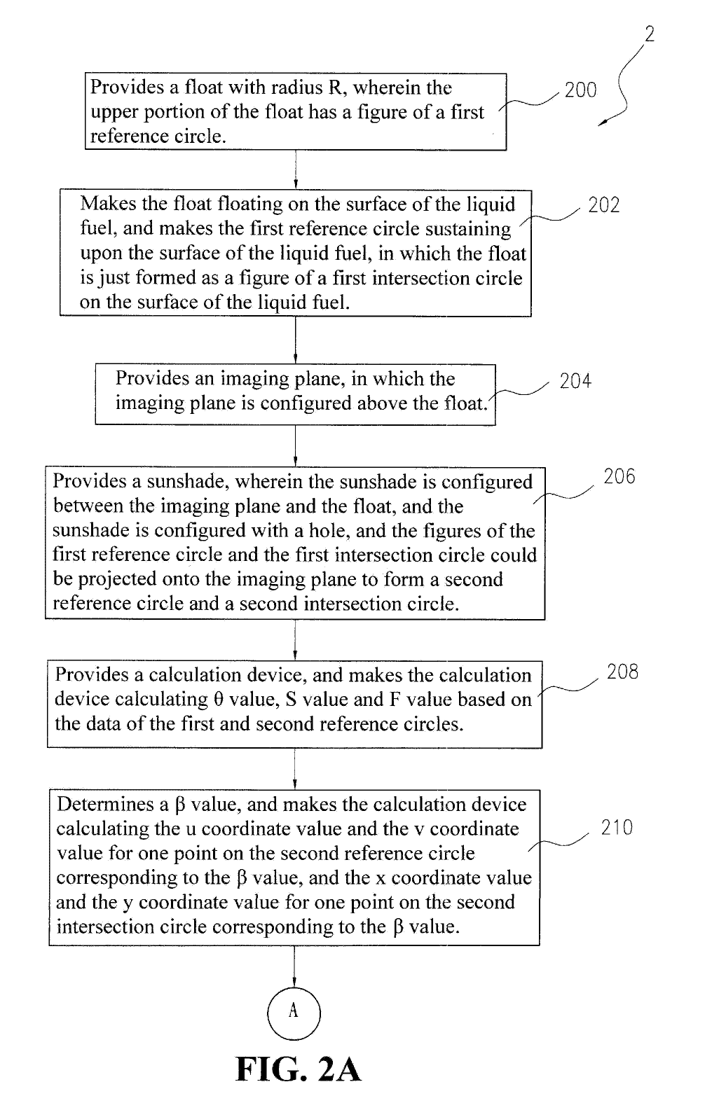

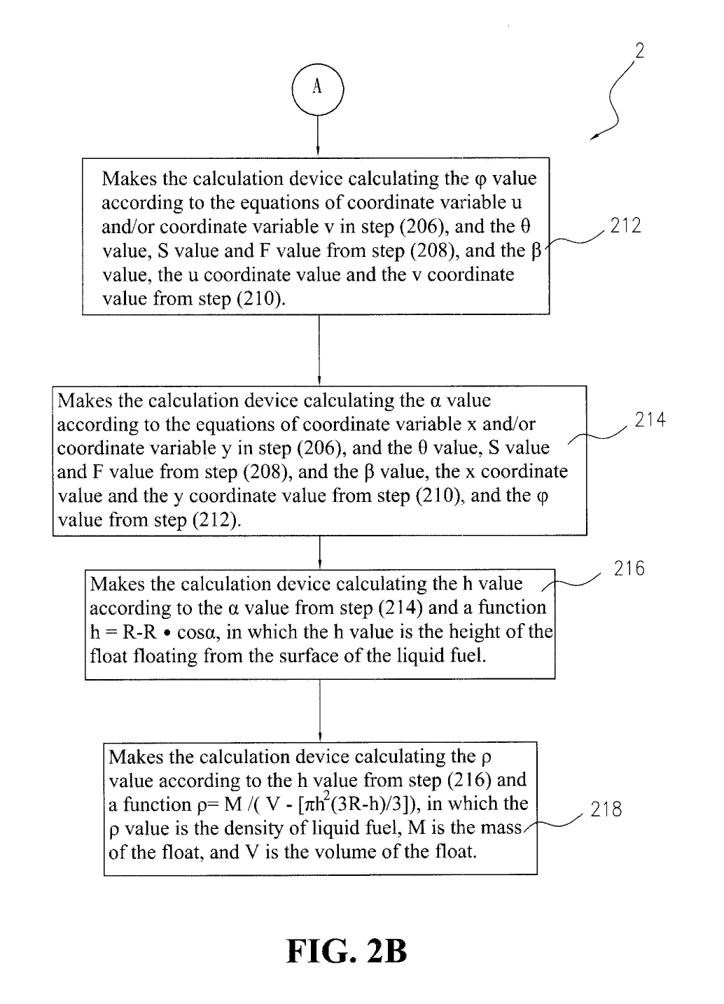

FIGS. 2A and 2B are the liquid fuel concentration detection method for liquid fuel cell according to the present invention. However, in order to describe the liquid concentration detection method 2 according to the present invention, it is described in association with the preferred embodiments shown in FIG. 1A and 1B. As shown in FIGS. 2A and 2B, the liquid fuel concentration detection method 2 according to the present invention includes the step 200 to step 218, which are described individually in the following context. Step 200 provides a float 12 with radius R, wherein the upper portion of the float 12 has a figure of a first reference circle 120, and the radius of the first reference circle 120 is r (as shown in FIG. 1A), and the angle formed by one point on the first reference circle 120, the center of mass for the float 12, and the center of circle for the first reference circle 120 is α1.

Step 202 is to make the float 12 floating on the surface of the liquid fuel 11, and make the first reference circle 120 sustaining upon the surface of the liquid fuel 11, in which the float 12 is just formed as a figure of a first intersection circle 122 on the surface of the liquid fuel 11.

Step 204 provides an imaging plane 140, in which the imaging plane 140 is configured above the float 12 in Step 200. As shown in FIG. 1B, because of the structure of image capture device 14 itself, usually the imaging plane 140 and the surface of the liquid fuel 11 (as indicated by horizontal line 110) could be possibly formed with an angle difference, that is, the angle φ.

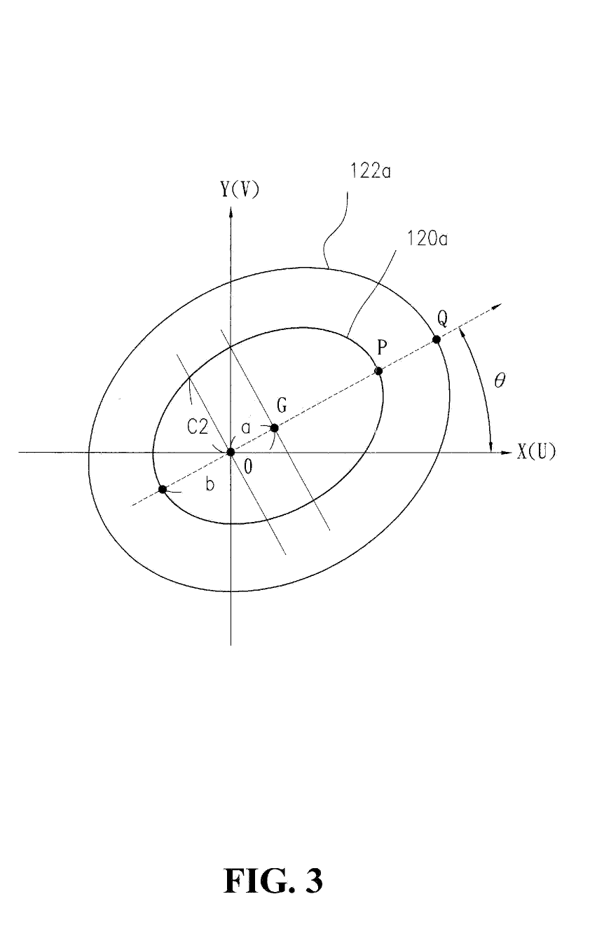

Step 206 provides a sunshade 16, wherein the sunshade 16 is configured between the imaging plane 140 and the float 12. As shown in FIGS. 1A and 1B, the sunshade 16 is configured with a hole 160, and the vertical distance between the hole 160 and the imaging plane 140 is f, and the vertical distance between the hole 160 and the surface of liquid fuel 11 is F. Thus, the figures of the first reference circle 120 and the first intersection circle 122 could be projected onto the imaging plane 140, to form a second reference circle 120a and a second intersection circle 122a as shown in FIG. 3. In FIG. 3, each coordinate variable for the point coordinate (u, v) on the second reference circle 120a and the point coordinate (x, y) on the second intersection circle 122a could be applied with vector geometric operation with the space structure shown in FIG. 1B, and finally obtain the coordinate variables, u, v, x and y, which are satisfied for the following equations:

u=(S·cos θ·cos φ−R·cos α1·sin θ·cos φ+R·sin α1·cos(β+φ))·(−f)/(−S·sin θ−R·cos α1·cos θ+R·cos α1·F);

v=(S·cos θ·sin φ−R·cos α1·sin θ·sin φ+R·sin α1·sin(β+φ))·(−f)/(−S·sin θ−R·cos α1·cos θ+R·cos α1·F);

x=(S·cos θ·cos φ−R·cos α·sin θ·cos φ+·sin α·cos(β+φ))·(−f)/(−S·sin θ−R·cos α·cos θ+R·cos α−F);

y=(S·cos θ·sin φ−R·cos α·sin θ·sin φ+R·sin α·sin(β+φ))·(−f)/(−S·sin θ−R·cos α·cos θ+R·cos α−F);

wherein, S is the moving distance of the float 12 on the surface of liquid fuel 11; θ is the deflection angle of the float 12 on the surface of liquid fuel 11; β is the phase angle of one point on the first reference circle 120 to the center of circle, or the phase angle of one point on the first intersection circle 122 to the center of circle; α is the angle formed by one point on the first intersection circle 122, the center of mass 124 of the float 12, and the center of circle of the first intersection circle 122, and the value of α is not less than α1.

Furthermore, Step 208 provides a calculation device 18, and makes the calculation device 18 calculating θ value, S value and F value, based on the data of the first reference circle 120 and the second reference circle 120a; wherein, θ value employs the conventional image processing algorithm, in which the calculation device 18 could calculate the angle θ in FIG. 3, i.e. θ value, based on variation of the second reference circle 120a on the imaging plane 140. As for S value and F value, they could be calculated with the ratio relationship between the first reference circle 120 and the second reference circle 120a in the vector space of FIG. 1B; wherein, S value is calculated by the calculation device 18 based on the function S=r·(a/b); wherein, a is the distance between the geometrical center G of the second reference circle 120a and the origin 0 of the imaging plane 140; b is the distance between one point on the second reference circle 120a in the line GO direction and the geometrical center G; moreover, F value is calculated by the calculation device 18 based on the function F=f·(c1/c2); wherein, c2 is the distance between one point on the second reference circle 120a in the direction vertical to line GO passing the origin 0 and the geometrical center G; and, c1 is calculated by the function c1=√(r²−S²).

Thus, the calculation device 18 could calculate the concentration of liquid fuel 11, and calculate the vertical distance F between the hole 160 and the surface of liquid fuel 11 based on the data of the first and second reference circles 120, 120a and the first and second intersection circles 122, 122a, so as to obtain the level of liquid fuel 11 within the container 10.

Step 210 is to determine a β value, and make the calculation device 18 calculating the u coordinate value and the v coordinate value for one point on the second reference circle 120a corresponding to the β value, and the x coordinate value and the y coordinate value for one point on the second intersection circle 122a corresponding to the β value. As shown in FIG. 3, assuming the β value is determined as 0, the points on the second reference circle 120a and the second intersection circle 122a corresponding to β=0 are P and Q, and the u coordinate value and the v coordinate value of point P, and the x coordinate value and the y coordinate value of point Q are calculated by the calculation device 18.

Step 212 is to make the calculation device 18 calculating the φ value according to the equations of coordinate variable u and/or coordinate variable v in Step 206, and the θ value, S value and F value calculated from Step 208, and β value (=0) from Step 210, and the u coordinate value and the v coordinate value for point P. Of course, the β value used in the present invention could not only be limited as 0, but also be any angle between 0 and 2π.

Step 214 is to make the calculation device 18 calculating the α value according to the equations of coordinate variable x and/or coordinate variable y in Step 206, and the θ value, S value and F value calculated from Step 208, and β value (=0) from Step 210, and the x coordinate value and the y coordinate value for point Q, and the φ value from Step 212. Similarly, the β value used herein could not only be limited as 0, but also be any angle between 0 and 2π.

Step 216 is to make the calculation device 18 calculating the h value according to the α value from Step 214 and a function h=R−R·cos α, and further calculate the height h of the float 12 floating from the surface of the liquid fuel 11.

Finally, Step 218 is to make the calculation device 18 calculating the ρ value according to the h value from Step 216 and a function ρ=M/(V−[π·h²(3·R−h)/3]); wherein, the ρ value is the concentration of liquid fuel 11, M is the mass of the float 12, and V is the volume of the float 12.

Finally, the features and effects of the present invention could be concluded as follows:

1. The concentration detection method for liquid fuel according to the present invention is based on image processing and vector geometry, and extended for applying on concentration detection of liquid fuel for liquid fuel cell, and employs the mathematical calculation to achieve the purpose of concentration detection. Based on this feature, the concentration detection operation for liquid fuel according to the present invention could be realized by software calculation, so as to reduce the hardware cost to the minimum; and
2. The concentration detection device according to the present invention has a low manufacturing cost, and could be easily manufactured in mass production, and could have much convenience for concentration sensing operation of liquid fuel, which should be the advantage of the present invention.

The present invention has been described as above. Thus, the disclosed embodiments are not limiting the scope of the present invention. And, for the skilled in the art, it is well appreciated that the change and modification without departing from the claims of the present invention should be within the spirit and scope of the present invention, and the protection scope of the present invention should be defined with the attached claims.

What is claimed is:

1. A concentration detection method of liquid fuel for liquid fuel cell, comprising the steps of:
(a) providing a float with radius R, wherein the upper portion of the float has a figure of a first reference circle, and the radius of the first reference circle is r, and the angle formed by one point on the first reference circle, the center of mass for the float, and the center of circle for the first reference circle is α1,
(b) making the float floating on the surface of the liquid fuel, and making the first reference circle sustaining upon the surface of the liquid fuel, in which the float is just formed as a figure of a first intersection circle on the surface of the liquid fuel;
(c) providing an imaging plane, in which the imaging plane is configured above the float in step (a);
(d) providing a sunshade, in which the sunshade is configured between the imaging plane and the float, and the sunshade is configured with a hole, and the vertical distance between the hole and the imaging plane is f, so the figures of the first reference circle and the first intersection circle could be respectively projected onto the imaging plane through the hole to form a second reference circle and a second intersection circle, in which each coordinate variable for the point coordinate (u, v) on the second reference circle and the point coordinate (x, y) on the second intersection circle could be satisfied with the following equations:
u=(S·cos θ·cos φ−R·cos α1·sin θ·cos φ+R·sin α1·cos(β+φ))·(−f)/(−S·sin θ−R·cos α1·cos θ+R·cos α1·F);
v=(S·cos θ·sin φ−R·cos α1·sin θ·sin φ+R·sin α1·sin(β+φ))·(−f)/(−S·sin θ−R·cos α1·cos θ+R·cos α1·F);
x=(S·cos θ·cos φ−R·cos α·sin θ·cos φ+·sin α·cos(β+φ))·(−f)/(−S·sin θ−R·cos α·cos θ+R·cos α−F);
y=(S·cos θ·sin φ−R·cos α·sin θ·sin φ+R·sin α·sin(β+φ))·(−f)/(−S·sin θ−R·cos α·cos θ+R·cos α−F);
wherein, S is the moving distance of the float on the surface of liquid fuel, θ is the deflection angle of the float on the surface of liquid fuel, φ is the angle between the imaging plane and the surface of the liquid fuel, β is the phase angle of one point on the first reference circle to the center of circle, or the phase angle of one point on the first intersection circle to the center of circle, F is the vertical distance between the hole and the surface of liquid fuel, α is the angle formed by one point on the first intersection circle, the center of mass of the float, and the center of circle of the first intersection circle;
(e) providing a calculation device, and making the calculation device calculating θ value, S value and F value, based on the data of the first reference circle and the second reference circle;
(f) determining a β value, and making the calculation device calculating the u coordinate value and the v coordinate value for one point on the second reference circle corresponding to the β value, and the x coordinate value and the y coordinate value for one point on the second intersection circle corresponding to the β value,
(g) making the calculation device to calculate the φ value according to the equations of coordinate variable u and/or coordinate variable v in step (d), and the θ value, S value and F value calculated from step (e), and the β value, the u coordinate value, and the v coordinate value from step (f);
(h) making the calculation device calculating the α value according to the equations of coordinate variable x and/or coordinate variable y in step (d), and the θ value, S value and F value calculated from step (e), and the β value, the x coordinate value and the y coordinate value from step (f), and the φ value from step (g);
(i) making the calculation device calculating the h value according to the α value from step (h) and a function h=R−R·cos α, in which the h value is the height h of the float floating from the surface of the liquid fuel;
(j) making the calculation device calculating the p value according to the h value from step (i) and a function ρ=M/(V−[π·h²(3·R−h)/3]), in which the ρ value is the concentration of liquid fuel, and M is the mass of the float, and V is the volume of the float.

2. The concentration detection method of liquid fuel according to claim 1, wherein, in step (e), the calculation device could calculate the S value based on a function S=r·(a/b), wherein a is the distance between the geometrical center G of the second reference circle and the origin 0 of the imaging plane, and b is the distance between one point on the second reference circle in the line GO direction and the geometrical center G.

3. The concentration detection method of liquid fuel according to claim 2, wherein, in step (e), the calculation device could calculate the F value based on a function F=f·(c1/c2), wherein c2 is the distance between one point on the second reference circle in the direction vertical to line GO passing the origin O and the geometrical center G; and, c1 is calculated by the function c1=√(r²−S²).

4. The concentration detection method of liquid fuel according to claim 1, wherein the β value in step (f) is between 0 and 2π.

5. The concentration detection method of liquid fuel according to claim 1, wherein the α value in step (f) is not less than α1.

6. A concentration detection device, which is used to detect the concentration of liquid fuel within a container, the concentration detection device comprises:
a float, which is floating on the surface of liquid fuel, wherein the upper portion of the float has a figure of a first reference circle, and the float is just formed as a figure of a first intersection circle on the surface of liquid fuel;
an image capture device with an imaging plane, wherein the imaging plane is configured upon the float;
a sunshade, which is configured between the imaging plane and the float, in which the sunshade is configured with a hole, so the figures of the first reference circle and the first intersection circle could be respectively projected onto the imaging plane through the hole to form a second reference circle and a second intersection circle;
a calculation device, which could calculate the concentration of the liquid fuel according to the first and second reference circles and the first and second intersection circles.

7. The concentration detection device according to claim 6, wherein the float is a ball.

8. The concentration detection device according to claim 6, wherein the image capture device is a CCD sensing device.

9. The concentration detection device according to claim 6, wherein the image capture device is a CMOS sensing device.

10. The concentration detection device according to claim 6, further comprises at least one light emitting device, which are configured on the inner wall of the container, below the sunshade, and above the surface of the liquid fuel.

11. The concentration detection device according to claim 6, wherein the container is a fuel supply tank for supplying the fuel required by a liquid fuel cell.

12. The concentration detection device according to claim 6, wherein the liquid fuel is a methanol aqueous solution.

13. The concentration detection device according to claim 10, wherein the light emitting device is a light emitting diode.

14. The concentration detection device according to claim 11, wherein the liquid fuel cell is a direct methanol fuel cell.

15. The concentration detection device according to claim 6, wherein the calculation device could calculate the vertical distance between the hole and the surface of the liquid fuel based on the data of the first and second reference circles, and the first and second intersection circles to obtain the level of the liquid fuel within the container.
